(19) United States
(12) Patent Application Publication
(10) Pub. No.: US 2023/0236347 A1
(43) Pub. Date: Jul. 27, 2023

(54) REFLECTIVE ULTRAVIOLET WIRE GRID POLARIZER

(71) Applicant: Moxtek, Inc., Orem, UT (US)

(72) Inventors: Matthew C. George, Lindon, UT (US); Daniel Bacon-Brown, Sandy, UT (US); R. Stewart Nielson, Pleasant Grove, UT (US); Shaun Patrick Ogden, Saratoga Springs, UT (US)

(21) Appl. No.: 18/095,322

(22) Filed: Jan. 10, 2023

Related U.S. Application Data
(60) Provisional application No. 63/303,096, filed on Jan. 26, 2022.

(51) Int. Cl. G02B 5/30

(52) U.S. Cl. CPC G02B 5/3058

(57) ABSTRACT

The reflective wire grid polarizers herein can withstand ultraviolet light without rapid degradation and can have high performance in the ultraviolet spectrum. In one example, each wire can include a metal layer, a pair of low index layers, a silicon layer, and a high index layer. The metal layer can be sandwiched between the pair of low index layers. The metal layer and the pair of low index layers can be sandwiched between the silicon layer and the high index layer. In another example, each wire can include a metal layer and a silicon layer. The silicon layer can be thicker than the metal layer. Thus, the silicon layer can be relatively thick, and can be the main polarizing component of the wire. The metal layer can be added for increased reflectance.

### CLAIM OF PRIORITY

This application claims priority to U.S. Provisional Pat. Application Number US 63/303,096, filed on Jan. 26, 2022, which is incorporated herein by reference.

### FIELD OF THE INVENTION

The present application is related to wire grid polarizers in the ultraviolet spectrum.

### BACKGROUND

A wire grid polarizer can divide light into two different polarization states. One polarization state can primarily pass through the wire grid polarizer and the other polarization state can be primarily absorbed or reflected. The effectiveness or performance of wire grid polarizers is based on high transmission of a predominantly-transmitted polarization state (sometimes called Tp) and minimal transmission of an orthogonal polarization state (sometimes called Ts).

It can be beneficial to have high contrast (Tp/Ts). Contrast can be improved by increasing transmission of the predominantly-transmitted polarization state (e.g. increasing Tp) and by decreasing transmission of the orthogonal polarization state (e.g. decreasing Ts).

### BRIEF DESCRIPTION OF THE DRAWINGS (DRAWINGS MIGHT NOT BE DRAWN TO SCALE)

FIG. 1 is a cross-sectional side-view of a reflective wire grid polarizer 10 with an array of wires 16 on a substrate 17. Each wire 16 can include a silicon layer 11, a metal layer 12, a pair of low index layers 13, and a high index layer 14.

FIG. 2 is a cross-sectional side-view of a reflective wire grid polarizer 20 with an array of wires 16 on a substrate 17. Each wire 16 can include a silicon layer 11 and a metal layer 12. The silicon layer 11 can be thicker than the metal layer 12 (T1 > T2). The silicon layer 11 can be closer to the substrate 17 than the metal layer 12.

FIG. 3 is a cross-sectional side-view of a reflective wire grid polarizer 30 with an array of wires 16 on a substrate 17. Each wire 16 can include a metal layer 12 and a silicon layer 11. The metal layer 12 can be thicker than the silicon layer 11 (T2 > T1). The metal layer 12 can be closer to the substrate 17 than the silicon layer 11.

FIG. 4 is a cross-sectional side-view of a system for polarizing ultraviolet light, with a wire grid polarizer 42 as described herein. The system can include a reflector 45, a light source 44, a quarter-wave-plate 43, and the wire grid polarizer 42.

Definitions. The following definitions, including plurals of the same, apply throughout this patent application.

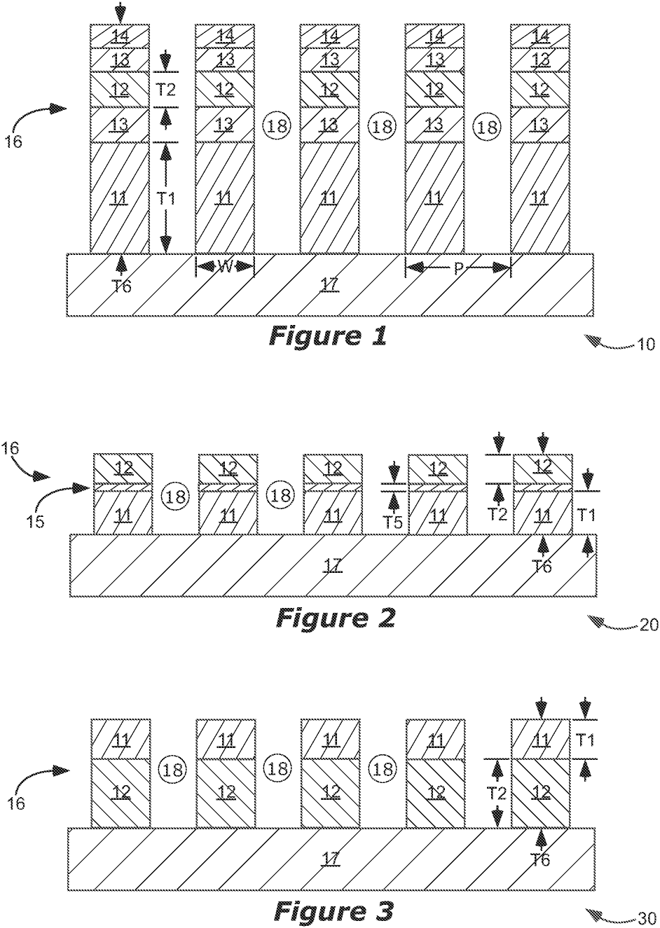

As used herein, the term “elongated” means that wire length is substantially greater than wire width W and wire thickness T6. Wire length is into the sheet of the figures and perpendicular to wire width W and wire thickness T6. For example, wire length can be at least 5 times, 100 times, 1000 times, or 10,000 times larger than wire width W, wire thickness T6, or both. See FIG. 1.

As used herein, the terms “on”, “located on”, “located at”, and “located over” mean located directly on or located over with some other solid material between. The terms “located directly on”, “adjoin”, “adjoins”, and “adjoining” mean direct and immediate contact.

Unless explicitly noted otherwise herein, all temperature-dependent values are such values at 25° C.

Materials used in optical structures can absorb some light, reflect some light, and transmit some light. Materials are divided into absorptive, reflective, and transparent varieties based on reflectance R, the refractive index n, and the extinction coefficient k. Equation 1 is used to determine the reflectance R of the interface between air and a uniform slab of the material at normal incidence:

$$R = \frac{{\left(n - 1\right)}^{2} + {k}^{2}}{{\left(n + 1\right)}^{2} + {k}^{2}}$$

Unless explicitly specified otherwise herein, materials with k ≤ 0.1 in the wavelength range are “transparent” materials, materials with k > 0.1 and R ≤ 0.6 in the specified wavelength range are “absorptive” materials, and materials with k > 0.1 and R > 0.6 in the specified wavelength range are “reflective” materials. If explicitly so stated in the claims, materials with k > 0.1 and R ≥ 0.7, R ≥ 0.8, or R ≥ 0.9, in the specified wavelength range, are “reflective” materials.

As used herein, the term “nm” means nanometer(s).

### DETAILED DESCRIPTION

A wire grid polarizer can divide light into two different polarization states. One polarization state can primarily pass through the wire grid polarizer and the other (orthogonal) polarization state can be primarily absorbed or reflected. The effectiveness or performance of wire grid polarizers is based on high transmission of a predominantly-transmitted polarization state (sometimes called Tp) and minimal transmission of the orthogonal polarization state (sometimes called Ts).

It can be beneficial to have high contrast (Tp/Ts). Contrast can be improved by increasing transmission of the predominantly-transmitted polarization state (e.g. increasing Tp) and by decreasing transmission of the orthogonal polarization state (e.g. decreasing Ts).

If the reflected light beam will be used, it can be helpful to have high reflectance of the orthogonal polarization state (e.g. high Rs). For a reflective wire grid polarizer, beamsplitting efficiency is a useful indicator of wire grid polarizer performance . Beamsplitting efficiency can be defined in various ways for a single-pass device, depending on how the beams and beamsplitter are utilized, and the degree of accuracy required. For example, beamsplitter efficiency could be defined as (Tp*Rs), 0.5*(Tp + Rs), or 0.5*(Tp + Tp*Rs) for a randomly polarized source when using both beams. For multiple-pass devices, beam-splitter efficiency can be defined in an even more complicated fashion.

The reflective wire grid polarizers herein can have high efficiency for ultraviolet light. They can withstand ultraviolet light without rapid degradation. They can have high performance in the ultraviolet spectrum.

As illustrated in FIGS. 1-3, reflective wire grid polarizers for the ultraviolet spectrum 10, 20, and 30 can include an array of wires 16 on a substrate 17. The array of wires 16 can be parallel and elongated. A pitch P of the wires 16 can be less than ½ of a lowest wavelength of a desired range of polarization. There can be a channel 17 between each pair of proximal wires 16. The channels 17 can be filled with air or other gas. vacuum, liquid, solid, or combinations thereof. Any solid or liquid in the channels 17 can be transparent.

Each wire can comprise a metal layer 12 and a silicon layer 11. The silicon layer 11 can be relatively thick, and can be the main polarizing component of the wire 16. Silicon is preferred over metal for polarization of ultraviolet light. The metal layer 12 can be added, however, for increased reflectance of the primarily-reflected polarization state (e.g. s-polarization) . A thickness T1 of the silicon layer 11 can be ≥ 30%, ≥ 40%, or ≥ 50% of a thickness T6 of the wire 16, thus making the silicon layer 11 the main polarizing component of the wire 16.

As illustrated in FIGS. 1-2, a thickness T1 of the silicon layer 11 can be greater than a thickness T2 of the metal layer 12 (T1 > T2), which can make the silicon layer 11 the main polarizing component of the wire 16, instead of the metal layer 12. For example, T1/T2 ≥ 1.25 or T1/T2 ≥ 1.5. Alternatively, as illustrated in FIG. 3, a thickness T2 of the metal layer 12 can be greater than a thickness T1 of the silicon layer 11 (T2 > T1), which can be acceptable in some applications if the silicon layer 11 is sufficiently thick.

The silicon layer 11 can be closest to the substrate 17. The silicon layer 11 can be closer to the substrate 17 than the metal layer 12, as shown in FIGS. 1 and 2. This arrangement can apply to wire grid polarizer 30. Alternatively, the silicon layer 11 can be farther from the substrate 17 than the metal layer 12, as shown in FIG. 3. This arrangement can apply to wire grid polarizers 10 and 20. A selection between these alternatives can be made based on direction of incoming light.

Example materials for the metal layer 12 include aluminum, iridium, magnesium, rhodium, or combinations thereof. For example, the metal layer 12 can include at least 90 mass percent aluminum, 90 mass percent iridium. 90 mass percent magnesium, or 90 mass percent rhodium. The silicon layer 11 can include at least 80 mass percent, 90 mass percent, 95 mass percent, or 99 mass percent silicon.

As illustrated in FIG. 1, each wire 16 can include a metal layer 12, a pair of low index layers 13, a silicon layer 11, and a high index layer 14. The metal layer 12 can be sandwiched between the pair of low index layers 13. The metal layer 12 and the pair of low index layers 13 can be sandwiched between the silicon layer 11 and the high index layer 14. Thus, an order of the layers in each wire 16 can be the silicon layer 11, one of the low index layers 13. the metal layer 12, the other low index layer 13, and then the high index layer 14.

Placing the metal layer 12 between the pair of low index layers 13 can reduce absorption of the ultraviolet light. The high index layer 14 can increase reflection of one polarization state of the ultraviolet light.

The pair of low index layers 13 can each have an index of refraction (n) that is less than or equal to 1.6 from 250 nm through 400 nm of the ultraviolet spectrum. The pair of low index layers 13 can each have an extinction coefficient (k) that is less than or equal to 0.1 from 250 nm through 400 nm of the ultraviolet spectrum. The pair of low index layers 13 can each include at least 90 mass percent silicon dioxide.

The high index layer 14 can have an index of refraction (n) that is greater than or equal to 1.65, 1.8, or 1.9 from 250 nm through 400 nm of the ultraviolet spectrum. The high index layer 14 can have an extinction coefficient (k) that is less than or equal to 0.1 from 250 nm through 400 nm of the ultraviolet spectrum. The high index layer 14 can include at least 90 mass percent hafnium oxide.

As illustrated in FIG. 1, each wire 16 can consist essentially of the silicon layer 11, the metal layer 12, the pair of low index layers 13, and the high index layer 14.

As illustrated in FIG. 3, each wire can consist essentially of the silicon layer 11 and the metal layer 12. Wire grid polarizer 20 can consist essentially of the silicon layer 11 and the metal layer 12 by removal of the silicon dioxide layer 15.

As illustrated in FIG. 2, each wire 16 can include a silicon dioxide layer 15 between the metal layer 12 and the silicon layer 11. This silicon dioxide layer 15, between the metal layer 12 and the silicon layer 11, can be used in any wire grid polarizer example herein.

The silicon dioxide layer 15 can prevent diffusion of material of the metal layer 12 into the silicon layer 11. The silicon dioxide layer 15 can prevent diffusion of material of the silicon layer 11 into the metal layer 12. Example minimum thicknesses T5 of the silicon dioxide layer include ≥1 nm, ≥ 2 nm, or ≥3 nm. Example maximum thicknesses T5 of the silicon dioxide layer include ≤ 5 nm, ≤ 7 nm, or ≤ 10 nm. The silicon dioxide layer 15 can be used with wire grid polarizer 30 in FIG. 3. The silicon dioxide layer 15 can be removed from wire grid polarizer 20 in FIG. 2.

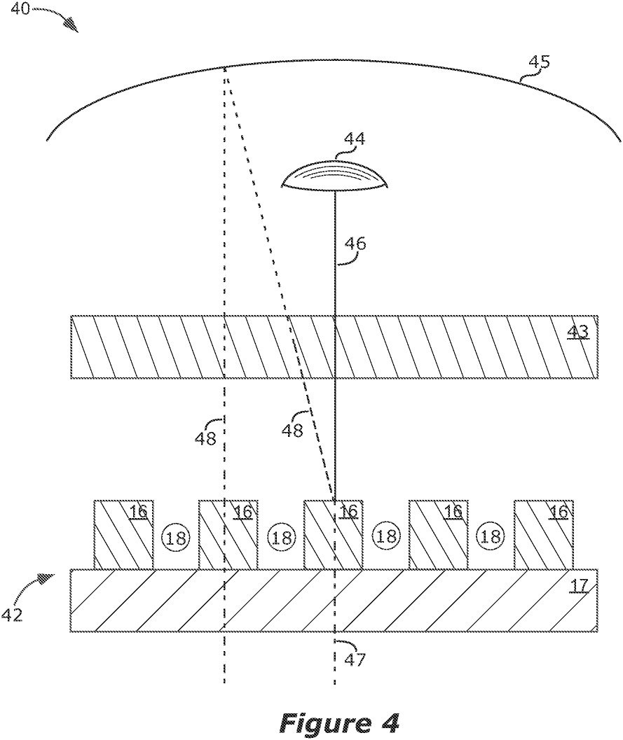

A system 40 for polarizing ultraviolet light is illustrated in FIG. 4. The system 40 can include a group of components in the following order: a reflector 45, a light source 44, a quarter-wave-plate 43, and a wire grid polarizer 42. The wire grid polarizer 42 can be any design described herein. The components can be positioned and oriented with respect to one another to direct light between the components. Additional optical components, such as reflectors, prisms, lenses, can also be positioned between the components described herein.

The light source 44 can be configured to shine ultraviolet light 46 through the quarter-wave-plate 43 to the wire grid polarizer 42. The light 46 can be randomly polarized. The wire grid polarizer 42 can be configured to polarize the light into a first beam 47 and a second beam 48. The first beam 47 can have a first polarization state (e.g. p-polarized light). The second beam 48 can initially have a second, orthogonal polarization state with respect to the first polarization state (e.g. s-polarized light). The first beam 47 can transmit through the wire grid polarizer 42. The second beam 48 can reflect back through the quarter-wave-plate 43 to the reflector 45.

The reflector 45 can then reflect the second beam 48 back through the quarter-wave-plate 43 to the wire grid polarizer 42. Thus, the second beam 48 can pass through the quarter-wave-plate 43 twice, which can convert the second beam 48 to the first polarization state. The second beam 48 can now pass through the wire grid polarizer 42.

A method of polarizing ultraviolet light, with a wire grid polarizer 42 described herein, can include some or all of the following steps. See FIG. 4. The method can include -----
(A) emitting ultraviolet light 46 through a quarter-wave-plate 43 to the wire grid polarizer 42;
(B) splitting the light 46, based on polarization state, into a first beam 47 and a second beam 48, the first beam 47 having predominantly a first polarization state and the second beam 48 having predominantly a second, orthogonal polarization state;
(C) passing the first beam 47 through the wire grid polarizer 42;
(D) reflecting the second beam 48 off of the wire grid polarizer 42;
(E) passing the second beam 48 through the quarter-wave-plate 43 to a reflector 45;
(F) reflecting the second beam 48 off of the reflector 45 back through the quarter-wave-plate 43, thus predominantly converting the second beam 48 to the first polarization state; and
(G) passing the second beam 48 through the wire grid polarizer 42.

The light 46 can be randomly polarized before it reaches the wire grid polarizer 42.

The first polarization state can be orthogonal to the second polarization state. The first polarization state can be p-polarized light. The second polarization state can be s-polarized light.

The second beam 48 can pass through the quarter-wave-plate 43 twice, thus predominantly converting it to the first polarization state. The second beam 48 can then pass through the wire grid polarizer 42, increasing the overall polarized ultraviolet light throughput of the system.

The terms “passing” and “reflecting” mean mostly passing and mostly reflecting the light beams, respectively. Due to imperfections in wire grid polarizers, perfect separation of the two polarization states is not expected. Due to imperfections in quarter-wave-plates 43, perfect conversion from one polarization state to the orthogonal polarization state upon two passes through the quarter-wave-plate is not expected.

As illustrated in FIG. 4, the quarter-wave-plate 43 can be spaced apart from, and can be a separate optical element than, the wire grid polarizer 42. Alternatively, the quarter-wave-plate 43 can adjoin the wire grid polarizer 42. A transparent spacer layer can adjoin the quarter-wave-plate 43 and the wire grid polarizer 42. The transparent spacer layer can fill the channels 18 of the wire grid polarizer 42 partially or completely.

In another embodiment, not shown in FIG. 4, the quarter-wave-plate 43 can be located between the wires 16 and the substrate 17. The wire grid polarizer 42 can be rotated 180 such that the light first encounters the substrate 17. then the quarter-wave-plate 43. then the metal layer 12. and then the silicon layer 11.

In another embodiment, not shown in FIG. 4, the quarter-wave-plate 43 can be located on an opposite side of the substrate 17 from the wires 16. The light can first encounter the quarter-wave-plate 43, then the substrate 17, then then the metal layer 12, and then the silicon layer 11.

What is claimed is:

1. A reflective wire grid polarizer for the ultraviolet spectrum, the wire grid polarizer comprising:
an array of wires on a substrate with a channel between each pair of proximate wires:
each wire having a metal layer, a pair of low index layers, a silicon layer, and a high index layer;
the metal layer is sandwiched between the pair of low index layers;
the metal layer and the pair of low index layers are sandwiched between the silicon layer and the high index layer;
the metal layer includes aluminum, iridium, magnesium, rhodium, or combinations thereof;
the pair of low index layers each have an index of refraction (n) that is less than or equal to 1.6, and an extinction coefficient (k) that is less than or equal to 0.1, from 250 nm through 400 nm of the ultraviolet spectrum; and
the high index layer has an index of refraction (n) that is greater than or equal to 1.65, and an extinction coefficient (k) that is less than or equal to 0.1, from 250 nm through 400 nm of the ultraviolet spectrum.

2. The wire grid polarizer of claim 1, wherein a thickness of the silicon layer is at least 30% of a thickness of the wire.

3. The wire grid polarizer of claim 1, wherein the silicon layer is nearer the substrate and the metal layer farther from the substrate.

4. The wire grid polarizer of claim 1, wherein the metal layer includes at least 90 mass percent aluminum, 90 mass percent iridium, 90 mass percent magnesium, or 90 mass percent rhodium.

5. The wire grid polarizer of claim 1, wherein each wire consists essentially of the silicon layer, the metal layer, the pair of low index layers, and the high index layer.

6. The wire grid polarizer of claim 1, wherein the silicon layer includes at least 90 mass percent silicon, the metal layer includes at least 90 mass percent aluminum, the pair of low index layers include at least 90 mass percent silicon dioxide, and the high index layer includes at least 90 mass percent hafnium oxide.

7. A system for polarizing ultraviolet light with the wire grid polarizer of claim 1, to improve overall ultraviolet light throughput, the system comprising:
a group of components in the following order, a reflector, a light source, a quarter-wave-plate, and the wire grid polarizer;
the components of the group of components being positioned and oriented with respect to one another such that:
the light source configured and oriented to shine ultraviolet through the quarter-wave-plate to the wire grid polarizer;
the wire grid polarizer (a) configured to split the light into a first beam and a second beam, the first beam having predominantly a first polarization state and the second beam having predominantly a second, orthogonal polarization state with respect to the first polarization state, (b) configured to transmit the first beam, and (c) oriented to reflect the second beam back through the quarter-wave-plate to the reflector; and
the reflector oriented to reflect the second beam from the quarter-wave-plate back through the quarter-wave-plate to the wire grid polarizer, where the second beam is predominately transmitted by the wire grid polarizer.

8. A method of polarizing ultraviolet light with the wire grid polarizer of claim 1, to improve overall ultraviolet light throughput, the method comprising:
emitting ultraviolet light through a quarter-wave-plate to the wire grid polarizer;
splitting the light into a first beam and a second beam, the first beam having predominantly a first polarization state and the second beam having predominantly a second, orthogonal polarization state;
passing the first beam through the wire grid polarizer;
reflecting the second beam off of the wire grid polarizer;
passing the second beam through the quarter-wave-plate to a reflector and reflecting the second beam off of the reflector back through the quarter-wave-plate, thus converting the second beam to predominately the first polarization state; and
passing the second beam through the wire grid polarizer.

9. A reflective wire grid polarizer for the ultraviolet spectrum, the wire grid polarizer comprising:
an array of wires on a substrate with a channel between each pair of proximate wires;
each wire having a metal layer and a silicon laver; and
T1 > T2. where T1 is a thickness of the silicon layer and T2 is a thickness of the metal layer.

10. The wire grid polarizer of claim 9, wherein the silicon layer includes at least 95 mass percent silicon.

11. The wire grid polarizer of claim 9, wherein T1/T2 ≥ 1.25.

12. The wire grid polarizer of claim 9, wherein each wire consists essentially of the silicon layer and the metal layer.

13. The wire grid polarizer of claim 9, further comprising a silicon dioxide layer between the metal layer and the silicon layer.

14. The wire grid polarizer of claim 13, wherein:
a thickness of the silicon dioxide layer is at least 2 nm thick and not greater than 7 nm thick; and
the silicon dioxide layer adjoins the metal layer and the silicon layer.

15. The wire grid polarizer of claim 9, wherein a thickness of the silicon layer is at least 30% of a thickness of the wire.

16. The wire grid polarizer of claim 9, wherein the silicon layer is nearer the substrate and the metal layer farther from the substrate.

17. The wire grid polarizer of claim 9, wherein the metal layer includes aluminum, iridium, magnesium, rhodium, or combinations thereof.

18. The wire grid polarizer of claim 9, wherein the metal layer includes at least 90 mass percent aluminum, 90 mass percent iridium, 90 mass percent magnesium, or 90 mass percent rhodium.

19. A method of polarizing ultraviolet light with the wire grid polarizer of claim 9, to improve overall ultraviolet light throughput, the method comprising:
emitting ultraviolet light through a quarter-wave-plate to the wire grid polarizer;
splitting the light into a first beam and a second beam, the first beam having predominantly a first polarization state and the second beam having predominantly a second, orthogonal polarization state with respect to the first polarization state;
passing the first beam through the wire grid polarizer;
reflecting the second beam off of the wire grid polarizer;
passing the second beam through the quarter-wave-plate to a reflector and reflecting the second beam off of the reflector back through the quarter-wave-plate, thus converting the second beam to predominately the first polarization state; and
passing the second beam through the wire grid polarizer.

20. A system for polarizing ultraviolet light, the system comprising:
a group of components in the following order, a reflector, a light source, a quarter-wave-plate, and a wire grid polarizer;
the wire grid polarizer including an array of wires on a substrate with a channel between each pair of proximate wires, each wire having a metal layer and a silicon layer, and T1 > T2, where T1 is a thickness of the silicon layer and T2 is a thickness of the metal layer;
the light source configured to shine ultraviolet through the quarter-wave-plate to the wire grid polarizer;
the wire grid polarizer (a) configured to split the light into a first beam and a second beam, the first beam having predominantly a first polarization state and the second beam having predominantly a second, orthogonal polarization state with respect to the first polarization state, (b) configured to transmit the first beam, and (c) oriented to reflect the second beam back through the quarter-wave-plate to the reflector; and
the reflector configured to reflect the second beam from the quarter-wave-plate back through the quarter-wave-plate to the wire grid polarizer, where the second beam is predominately transmitted as the first polarization state.
